(19) United States
(12) Patent Application Publication
(10) Pub. No.: US 2003/0188779 A1
(43) Pub. Date: Oct. 9, 2003

(54) Air gap mounting sink for a backflow prevention device

(75) Inventor: Craig DeGarmo, Janesville, WI (US)

Correspondence Address: Teresa J. Welch, Michael Best & Friedrich LLP, One South Pinckney Street, P. O. Box 1806, Madison, WI, 53701-1806, US

(73) Assignee: DeGarmo Plumbing, Inc., Janesville, WI

(21) Appl. No.: 10/408,977

(22) Filed: Apr. 8, 2003

Related U.S. Application Data
(60) Provisional application No. 60/371,081, filed on Apr. 9, 2002.

(51) Int. Cl. F16K 24/00

(52) U.S. Cl. 137/216

(57) ABSTRACT

The present invention provides an air gap mounting sink for a backflow prevention device. The air gap sink comprises a wall mounting plate, a wall mounting plate having an upper and lower end; a pair of mounting brackets attached to the upper end of the wall mounting plate; and a sink basin mounted to the lower end of the wall mounting plate having a drain aperture. A backflow prevention valve is mounted to the mounting brackets such that the discharge output pipe of the device is position to vent any discharged water into the sink basin.

### CROSS REFERENCE TO RELATED APPLICATIONS

This application claims the benefit of the filing date of U.S. provisional application No. 60/371,081. This application is herein incorporated by reference.

### BACKGROUND OF INVENTION

The present invention relates to an air gap mounting sink for a backflow prevention device.

Backflow prevention is a major concern in every large commercial building. Heating and air conditioning systems of buildings rely on a constant supply of water. The most readily available source is the potable water supply in the building. Connecting a safe drinking water system to equipment/systems engaged in activities other than supplying drinking water (e.g., HVAC, sprinkler, process use, etc.) necessitates the usage of a backflow prevention device.

Backflow prevention devices safeguard reverse flows caused by backpressure or backsiphonage. These devices prevent toxic substances from equipment using potable water sources from contaminating the supply of drinking water.

U.S. Federal, State, and local laws contain extensive regulations on the need for backflow prevention devices in buildings.

A wide variety of backflow prevention devices are currently commonly used. One type is a reduced pressure backflow valve, exemplified by commercially available models 009 and 909 of Watts Regulator Co. A reduced pressure backflow valve consists of two independently acting spring loaded check valves separated by a spring loaded differential pressure relief valve, two resilient seated full ported shutoff valves, and four properly located resilient seated test cocks. During normal operation, the pressure between the two check valves, referred to as the zone of reduced pressure, is maintained at a lower pressure than the supply pressure. If either check valve leaks, the differential pressure relief valve maintains a differential pressure of at least two (2) psi between the supply pressure, and the zone between the two check valves, by discharging water to atmosphere.

Another method used to prevent backflow is an air gap separation. An air gap is a physical separation between the free flowing discharge end of a potable water supply pipeline and the overflow rim of an open or non-pressurized receiving vessel. An obstruction around or near an air gap may restrict the flow of air into the outlet pipe and nullify the effectiveness of the air gap to prevent backsiphonage. When the air flow is restricted, such as the case of an air gap located near a wall, the air gap separation must be increased.

A problem with existing reduced pressure backflow devices is that in the case of a reverse flow, the relief valve of the device releases water into the atmosphere. This release can cause water damage to the room into which it is released, e.g., such damage can be substantial when the backflow prevention device releases a catastrophic discharge (a water release of about 30 gallons per minute).

Previous methods of dealing with the water discharge from a backflow prevention device have utilized a system whereby a hose or pipe is connected on one end to the discharge output pipe of a backflow prevention device, and connected on the other end to a floor drain or other receiving receptacle. The hose or pipe can then direct any discharged water to a floor drain. This type of connection, however, presents its own backflow risk. In the case of a catastrophic release, such a system would be unable to drain the water away from the backflow prevention device fast enough and a backup would result. This backup would itself create a water backflow. An air gap from the discharge output pipe of a backflow prevention device is therefore needed to prevent any additional backflow.

### SUMMARY OF INVENTION

The present invention provides an air gap mounting sink for a backflow prevention device. The invention provides redundant backflow protection by providing an air gap separation from the discharge output pipe of a backflow prevention device. The invention also provides a means to route any discharged water to either a floor drain, or another suitable receptacle vessel, in order to prevent water damage to a room containing the backflow prevention device. The air gap mounting sink of the present invention is designed to handle the water released from a catastrophic discharge of a backflow prevention device.

Specifically, the air gap sink comprises a wall mounting plate having an upper and lower end, and two side edges; two mounting brackets; and a sink basin. The wall mounting plate is secured to a wall of a building. The two mounting brackets are connected to the upper end of the wall mounting plate, each bracket being connected adjacent to a different side edge of the wall mounting plate. Each mounting bracket comprises a base plate, an extension arm plate, and a backflow prevention device mounting plate. Each base plate of the mounting brackets is connected to the wall mounting plate. The extension arm plates of the mounting brackets are connected to the base plates, and extend perpendicularly outward from the base plates and the wall mounting plate. The backflow prevention device mounting plate is connected to the extension arm plate.

The sink basin is connected to the lower end of the wall mounting plate. The sink basin comprises two side walls; a front plate; a bottom plate having a top side, a bottom side, and a drain aperture; and a pipe connection nipple. The side walls of the sink basin connect to a wall mounting plate adjacent to the sides of the lower end of the wall mounting plate, and extend perpendicularly away from the wall mounting plate. The front plate of the sink basin is connected to the side walls, and the bottom plate is connected to the front plate and the side walls. The pipe connection nipple is connected to the bottom side of the bottom plate, and encircles the drain aperture such that water can flow through the drain aperture and the pipe nipple.

A backflow prevention device is connected to the backflow prevention device mounting plates of the mounting brackets. The backflow prevention device is mounted to the brackets such that the discharge output pipe of the device is positioned to vent any discharged water into the sink basin.

### BRIEF DESCRIPTION OF THE DRAWINGS

FIG. 1 is a top view of one embodiment of the air gap mounting sink of the present invention.

FIG. 2 is a perspective view of one embodiment of the air gap sink.

FIG. 3 is a perspective view of one embodiment of the air gap sink of the present invention with a reduced pressure backflow assembly mounted to it.

FIG. 4 is a perspective view of another embodiment of the air gap sink of the present invention.

FIG. 5 is a partial perspective view of one embodiment of the air gap sink of the present invention in use with a reduced pressure backflow assembly.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use of “including”, “having” and “comprising” and variations thereof herein is meant to encompass the items listed thereafter and equivalents thereof as well as additional items and equivalents thereof.

### DETAILED DESCRIPTION

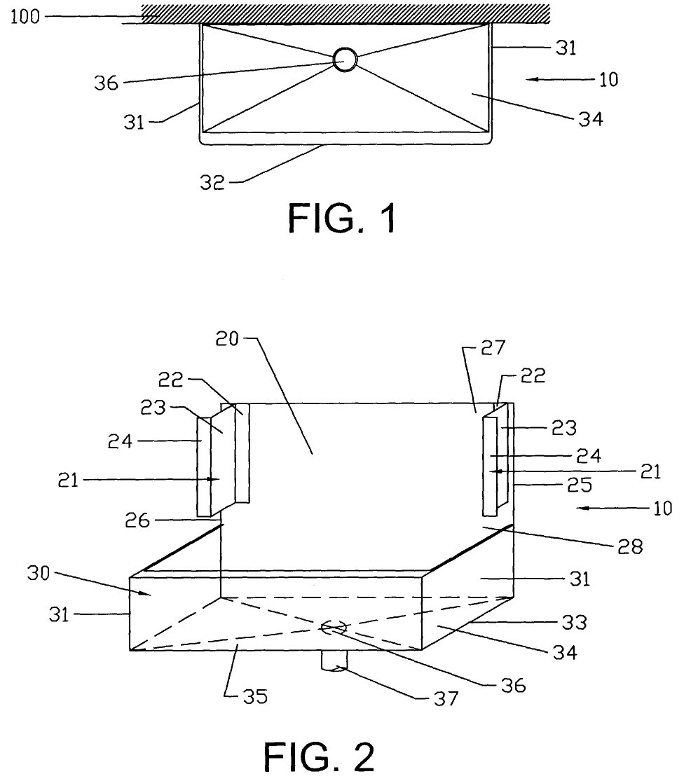

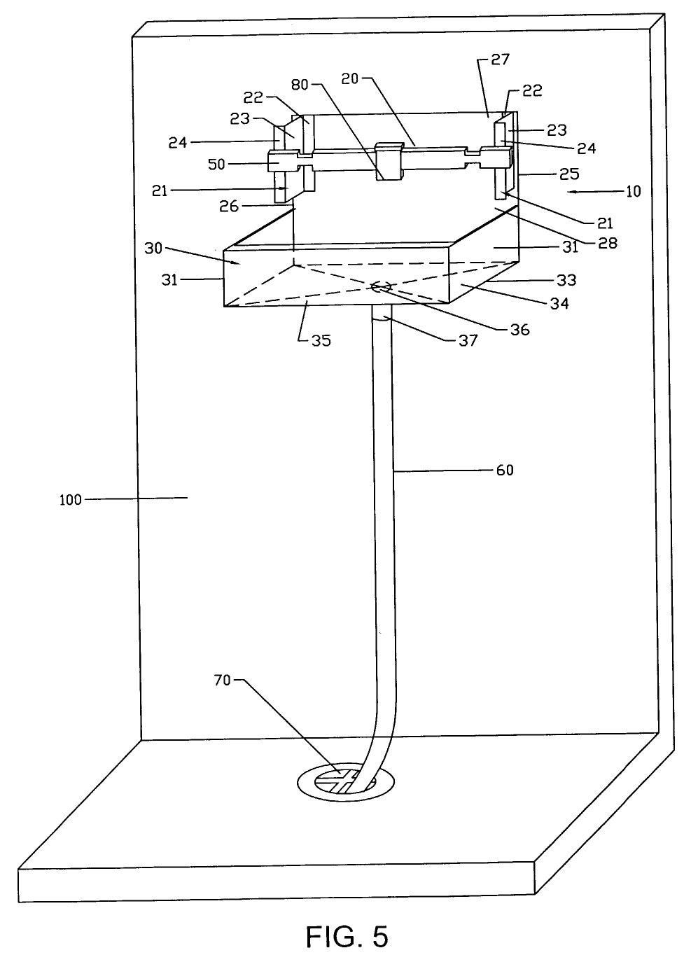

Reference is now made to FIGS. 1-5 which illustrate the present invention.

FIGS. 1-5 depict the air gap mounting sink of the present invention, generally designated as reference numeral 10. Air gap sink 10 in accordance with the present invention comprises a wall mounting plate 20 having an upper 27 and lower 28 end, a first side edge 25 and a second side edge 26, two mounting brackets 21; and a sink basin 30. The air gap sink 10 can be constructed out of stainless steal, or other durable materials.

The wall mounting plate 20 is secured to a wall 100 of a building. The plate can be secured by any standard fasteners (bolts, screws, nails, etc.). In one embodiment, the wall mounting plate 20 contains mounting apertures through which fasteners can pass, connecting the wall mounting plate 20 to the wall 100 of the building (not shown). Suitably, the wall mounting plate 20 is at least 24 inches wide so the plate can be mounted on standard spaced wall studs (16 inches apart). The two mounting brackets 21 are connected to the upper end 27 of the wall mounting plate 20, each bracket 21 being connected to the wall mounting plate 20 adjacent to the different side edges 25, 26 of the wall mounting plate 20.

Each mounting bracket 21 of the present invention comprises a base plate 22, an extension arm plate 23, and a backflow prevention device mounting plate 24. Suitably, each mounting bracket 21 may be of a unitary structure. This unitary structure can simply be a stamped piece of metal bent to shape the structure of the mounting bracket 21. The base plate 22 of a mounting bracket 21 is connected to the wall mounting plate 20 in any fashion, suitably by welding. The extension arm plate 23 of a mounting bracket 21 is connected to the base plate 22, and extends outward from the base plate 22 and the wall mounting plate 20. Suitably, the extension arm plate 23 extends out from the wall mounting plate 20 at least 4 inches. The backflow prevention device mounting plate 24 is connected to the extension arm plate 23.

The sink basin 30 is connected to the lower end 28 of the wall mounting plate 20. The sink basin 30 comprises two side walls 31; a front plate 32; a bottom plate 33 having a top side 34, a bottom side 35, a drain aperture 36; and a pipe connection nipple 37. Side walls 31 of the sink basin suitably can be welded or otherwise affixed to the wall mounting plate 20 adjacent to the side edges 25, 26 of lower end 28 of the wall mounting plate 20, and extend perpendicularly away from the wall mounting plate 20. The side walls 31 suitably extend outward from the wall mounting plate 20 by at least 10 inches. The front plate 32 of the sink basin 30 is connected to the side walls 31, and the bottom plate 33 is connected to the front plate 32 and the side walls 31. The side walls 31, front plate 32 and bottom plate 33 are suitably affixed together. The pipe connection nipple 37 is suitably attached to the bottom side 35 of the bottom plate 33, and encircles the drain aperture 36 such that water can flow through the drain aperture 36 and the pipe nipple 37.

Alternatively, the sink basin 30, pipe connection nipple 37, and wall mounting plate 20 can be a unitary structure, suitably formed from a stamped piece of metal. The sink basin 30, pipe connection nipple 37 and wall mounting plate 20 can also be formed from molded plastic.

A pipe or hose 60 can be connected to the pipe nipple 37 of the air gap sink of the present invention 10 and direct any water received by the sink 10 to a floor drain 70 or other water receiving receptacle.

Suitably, the drain aperture 36 and the pipe connection nipple 37 are at least 2 inches in diameter in order to handle draining water from a catastrophic water discharge from a backflow prevention device.

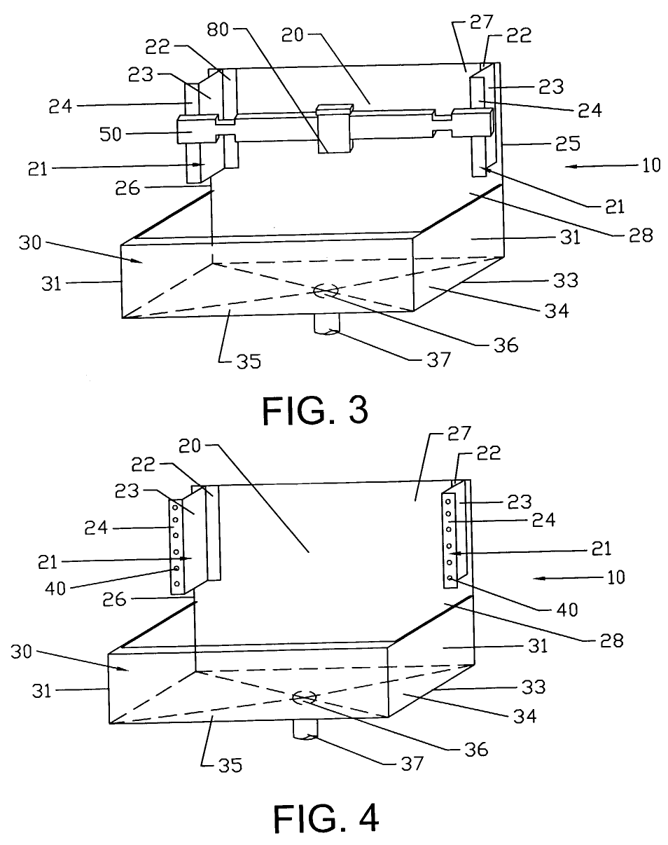

FIG. 3 depicts a reduced pressure backflow prevention device 50 mounted to the air gap mounting sink 10 of the present invention. The backflow prevention device 50 is connected to the backflow prevention device mounting plates 24 of the air gap mounting sink 10. Suitably, this is done by the use of pipe clamps. The backflow prevention device 50 is mounted so the emergency release vent 80 is positioned over the sink basin 30.

FIG. 4 depicts another embodiment of the present invention where the backflow prevention device mounting plates 24 of the air gap mounting sink 10 contain multiple mounting connection apertures 40. This allows for easy installation and accommodation of a number of different sized backflow prevention devices on the air gap mounting sink 10 of the present invention utilizing a number of commercially available fasteners such as pipe clamps.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

1. An air gap mounting system comprising:
a wall mounting plate having an upper and lower end;
a pair of mounting brackets attached to the upper end of the wall mounting plate; and
a sink basin mounted to the lower end of the wall mounting plate having a drain aperture.

2. The air gap system of claim 1 wherein the sink basin can receive a water discharge of up to 30 gallons per minute without the water overflowing the basin.

3. The air gap system of claim 1 wherein the drain aperture is at least 2 inches in diameter.

4. The air gap system of claim 1 wherein the mounting brackets contain multiple connection apertures.

5. The air gap system of claim 1 wherein a backflow prevention device is mounted to the mounting brackets.

6. The air gap system of claim 5 wherein the backflow prevention device is a reduced pressure backflow prevention valve.

7. An air gap mounting system comprising:
a wall mounting plate having an upper end, a lower end, a first side, and a second side;
a first mounting bracket having a base plate, an extension arm plate and a backflow prevention device mounting plate;
a second mounting bracket having a base plate, an extension arm plate and a backflow prevention device mounting plate;
a sink basin having a first side wall, a second side wall, a front plate and a bottom plate, wherein the bottom plate has a top side, a bottom side and a drain aperture;
wherein the first mounting bracket is attached to the wall mounting plate on the upper end adjacent to the first side;
wherein the second mounting bracket is attached to the wall mounting plate on the upper end adjacent to the second side; and
wherein the sink basin is attached to the lower end of the wall mounting plate.

8. The air gap system of claim 7 wherein the sink basin further comprises a pipe connection nipple attached to the bottom side of the bottom plate surrounding the drain aperture.

9. The air gap system of claim 7 wherein the first and second mounting brackets are each, separately, a unitary piece.

10. The air gap system of claim 7 wherein the drain aperture is at least 2 inches in diameter.

11. The air gap system of claim 10 wherein the sink basin further comprises a pipe connection nipple attached to the bottom side of the bottom plate surrounding the drain aperture.

12. The air gap system of claim 10 wherein the system further comprises a drain hose connected at one end to the pipe connection nipple and positioned at the other end to cover a floor drain.

13. The air gap system of claim 7 wherein the backflow prevention device mounting plate of the first mounting bracket and the backflow prevention device mounting plate of the second bracket each contain multiple connection apertures.

14. The air gap system of claim 7 wherein a backflow prevention device is mounted to the backflow prevention device mounting plates of the first and second mounting brackets.

15. The air gap system of claim 14 wherein the backflow prevention device is a reduced pressure backflow prevention valve.

16. The air gap system of claim 7 wherein the sink basin can receive a water discharge of up to 30 gallons per minute without the water overflowing the basin.

17. An air gap mounting system comprising:
a wall mounting plate having an upper end, a lower end, a first side, and a second side;
a first mounting bracket having a base plate, an extension arm plate and a backflow prevention device mounting plate, wherein the backflow prevention device mounting plate of the first mounting bracket contains multiple connection apertures;
a second mounting bracket having a base plate, an extension arm plate and a backflow prevention device mounting plate, wherein the backflow prevention device mounting plate of the second mounting bracket contains multiple connection apertures;
a sink basin having a first side wall, a second side wall, a front plate and a bottom plate, wherein the bottom plate has a top side, a bottom side and a drain aperture, wherein the drain aperture is at least two inches in diameter and wherein a pipe connection nipple is attached to the bottom side of the bottom plate surrounding the drain aperture;
wherein the first mounting bracket is attached to the wall mounting plate on the upper end adjacent to the first side;
wherein the second mounting bracket is attached to the wall mounting plate on the upper end adjacent to the second side;
wherein the sink basin is attached to the lower end of the wall mounting plate; and
wherein a reduced pressure backflow prevention valve is mounted to the backflow prevention device mounting plates of the first and second mounting brackets.

18. The air gap system of claim 17 wherein the sink basin can receive a water discharge of up to 30 gallons per minute without the water overflowing the basin.

19. The air gap system of claim 17 wherein the system further comprises a drain hose connected at one end to the pipe connection nipple and positioned at the other end to cover a floor drain.

20. The air gap system of claim 17 wherein the first and second mounting brackets are each, separately, a unitary piece.
